(19) United States
(12) Patent Application Publication
(10) Pub. No.: US 2007/0159580 A1
(43) Pub. Date: Jul. 12, 2007

(54) Polarizing plate, optical film and image display

(75) Inventors: Masahiro Yoshioka, Osaka (JP); Minoru Miyatake, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 10/583,083

(22) PCT Filed: Dec. 6, 2004
(86) PCT No.: PCT/JP04/18120

§ 371 Date: Jun. 15, 2006

(30) Foreign Application Priority Data
Dec. 19, 2003 (JP) 2003-423129

(51) Int. Cl. G02F 1/1335

(52) U.S. Cl. 349/117

(57) ABSTRACT

A polarizing plate of the invention comprises a polarizer and a protective film laminated on one side or both sides of the polarizer, wherein the polarizer comprises a film having a structure having a minute domain dispersed in a matrix formed of a translucent water-soluble resin including an iodine light absorbing material, and wherein the protective film satisfies an in-plane retardation of 20 nm or less, and a thickness direction retardation of 30 nm or less. The polarizing plate has a high polarization degree even on the short wavelength. Further, a polarizing plate of high polarization degree and high durability can be provided.

### TECHNICAL FIELD

The present invention relates to a polarizing plate. This invention also relates to an optical film using the polarizing plate concerned. Furthermore, this invention relates to an image display, such as a liquid crystal display, an organic electroluminescence display, a CRT and a PDP using the polarizing plate and the optical film concerned.

### BACKGROUND ART

Liquid crystal display are rapidly developing in market, such as in clocks and watches, cellular phones, PDAs, notebook-sized personal computers, and monitor for personal computers, DVD players, TVs, etc. In the liquid crystal display, visualization is realized based on a variation of polarization state by switching of a liquid crystal, where polarizers are used based on a display principle thereof. Particularly, usage for TV etc. increasingly requires display with high luminance and high contrast, polarizers having higher brightness (high transmittance) and higher contrast (high polarization degree) are being developed and introduced.

As polarizers, for example, since it has a high transmittance and a high polarization degree, polyvinyl alcohols having a structure in which iodine is absorbed and then stretched, that is, iodine based polarizers are widely used (for example, Japanese Patent Laid-Open No.2001-296427). However, since the iodine based polarizers have relatively low polarization degrees in short wavelength side, they have problems in hue, such as blue omission in black viewing, and yellowing in white viewing, in short wavelength side.

Iodine based polarizers may easily give unevenness in a process of iodine absorption. Accordingly, there has been a problem that the unevenness is detected as unevenness in transmittance particularly in the case of black viewing, causing to decrease of visibility. For example, as methods for solving the problems, several methods have been proposed that an amount of absorption of iodine absorbed to the iodine based polarizer is increased and thereby a transmittance in the case of black viewing is set not higher than sensing limitations of human eyes, and that stretching processes generating little unevenness itself are adopted. However, the former method has a problem that it decreases a transmittance in the case of white viewing, while decreasing a transmittance of black viewing, and as a result darkens the display itself. And also, the latter method has a problem that it requires replacing a process itself, worsening productivity.

A polarizer has been conventionally used as a polarizing plate obtained by sandwiching the polarizer between protective films such as triacetyl cellulose films. Since a triacetyl cellulose film has retardation, however, it is insufficient as a protective film because of the problem associated with a hue.

In recent years, a liquid crystal display has been employed in every field. Therefore, it is necessary that the use in severe conditions is within expectation, which requires a polarizing plate less in changes in characteristics such as light transmittance, polarization degree, and a hue of an image, and excellent in durability even in an environment at a high temperature and a high humidity. In fields where a high thermal reliability is required in an environment at a high humidity and a high temperature, such as outdoor uses and the on-board use of a vehicle, however, degradation in characteristics of a polarizing plate caused by intrusion of excessive water has become a great problem because of a high water-vapor permeability and a high water absorption coefficient of the triacetyl cellulose films. Therefore, it has been studied to use a transparent film less in water-vapor permeability and water absorption coefficient as a protective layer for a polarizer made from polyvinyl alcohol (for example, Japanese Patent Application Laid-Open H06-51117, Japanese Patent Application Laid-Open H07-77608, and Japanese Patent Application Laid-Open H11-142645).

However, since a polarizer made from polyvinyl alcohol is hydrophilic, therefore, a polarizer itself is inherently high in hygroscopicity, a simple use of a film that is low in water-vapor permeability and water absorption coefficient as a protective film, as described above, hinders permeation of water vaporized from the polarizer, which entails a state with a high temperature and high humidity in the inside of the polarizer itself, with the results that changes in light transmittance and polarization degree are larger, thereby leading to a low reliability as a polarizing plate.

### DISCLOSURE OF INVENTION

This invention aims at providing a polarizing plate, in which a protective film is laminated on one side or both sides of a polarizer, having a high polarization degree even on the short wavelength. Further this invention aims at providing a polarizing plate having a high polarization degree and excels in durability.

Moreover, this invention aims at providing a polarizing plate having a high transmittance and a high polarization degree, and being able to control unevenness of the transmittance in the case of black viewing, further providing a polarizing plate excels in durability.

Besides, this invention aims at providing an optical film using the polarizer concerned. Furthermore, this invention aims at providing an image display using the polarizing plate and the optical film concerned.

As a result of examination wholeheartedly performed by the present inventors that the above-mentioned subject should be solved, it was found out that the above-mentioned purpose might be attained using polarizing plate shown below, leading to completion of this invention.

That is, this invention relates to a polarizing plate comprising a polarizer and a protective film laminated on one side or both sides of the polarizer:

wherein the polarizer comprises a film having a structure having a minute domain dispersed in a matrix formed of a translucent water-soluble resin including an iodine light absorbing material, and;

wherein the protective film satisfies an in-plane retardation, which is expressed by Re=(nx−ny) x d, of 20 nm or less, and a thickness direction retardation, which is expressed by Rth={(nx+ny)/2−nz} x d, of 30 nm or less,

where the direction along with the refractive index in the film plane is maximum is defined as the X-axis, a direction perpendicular to the X-axis as the Y-axis, the thickness direction of the film as the Z-axis, and where refractive indices in each axial direction are defined as nx, ny, and nz, respectively, and the thickness of the film as d (nm).

The minute domain of the above-mentioned polarizer is preferably formed by an oriented birefringent material. The above-mentioned birefringent material preferably shows liquid crystallinity at least in orientation processing step.

The above-mentioned polarizer of this invention has an iodine based polarizer formed by a translucent water-soluble resin and an-iodine based light absorbing material as a matrix, and has dispersed minute domains in the above-mentioned matrix. Minute domains are preferably formed by oriented materials having birefringence, and particularly minute domains are formed preferably with materials showing liquid crystallinity. Thus, in addition to function of absorption dichroism by iodine based light absorbing materials, characteristics of having function of scattering anisotropy improve polarization performance according to synergistic effect of the two functions, and as a result a polarizer having both of transmittance and polarization degree, and excellent visibility may be provided.

Iodine based light absorbing material means chemical species comprising iodine and absorbs visible light, and it is thought that, in general, they are formed by interaction between translucent water-soluble resins (particularly polyvinyl alcohol based resins) and poly iodine ions (I₃-, I₅-, etc.). An iodine based light absorbing material is also called an iodine complex. It is thought that poly iodine ions are generated from iodine and iodide ions.

Scattering performance of anisotropic scattering originates in refractive index difference between matrixes and minute domains. For example, if materials forming minute domains are liquid crystalline materials, since they have higher wavelength dispersion of Δn compared with translucent water-soluble resins as a matrix, a refractive index difference in scattering axis becomes larger in shorter wavelength side, and, as a result, it provides more amounts of scattering in shorter wavelength. Accordingly, an improving effect of large polarization performance is realized in shorter wavelengths, compensating a relative low level of polarization performance of an iodine based polarizer in a side of shorter wavelength, and thus a polarizer having high polarization and neutral hue may be realized.

In the polarizing plate of the present invention employs a protective film small in retardation, thereby, almost perfectly enabling an optical coloration problem associated with a protective film to be dissolved. An in-plane retardation of a protective film is preferably 20 nm or less and more preferably 10 nm or less. A thickness direction retardation is preferably 30 nm or less and more preferably 20 nm or less.

In the above-mentioned polarizing plate, it is preferable that the minute domains of the polarizer have a birefringence of 0.02 or more. In materials used for minute domains, in the view point of gaining larger anisotropic scattering function, materials having the above-mentioned birefringence may be preferably used.

In the above-mentioned polarizing plate, in a refractive index difference between the birefringent material forming the minute domains of the polarizer and the translucent water-soluble resin in each optical axis direction, a refractive index difference (Δn¹) in direction of axis showing a maximum is 0.03 or more, and a refractive index difference (Δn²) between the Δn¹ direction and a direction of axes of two directions perpendicular to the Δn¹ direction is 50% or less of the Δn¹.

Control of the above-mentioned refractive index difference (Δn¹) and (Δn²) in each optical axis direction into the above-mentioned range may provide a scattering anisotropic film having function being able to selectively scatter only linearly polarized light in the Δn¹ direction, as is submitted in U.S. Pat. No. 2,123,902 specification. That is, on one hand, having a large refractive index difference in the Δn¹ direction, it may scatter linearly polarized light, and on the other hand, having a small refractive index difference in the Δn² direction, and it may transmit linearly polarized light. Moreover, refractive index differences (Δn²) in the directions of axes of two directions perpendicular to the Δn¹ direction are preferably equal.

In order to obtain high scattering anisotropy, a refractive index difference (Δn¹) in a Δn¹ direction is set 0.03 or more, preferably 0.05 or more, and still preferably 0.10 or more. A refractive index difference (Δn²) in two directions perpendicular to the Δn¹ direction is 50% or less of the above-mentioned Δn¹, and preferably 30% or less.

In iodine based light absorbing material in the above-mentioned polarizing plate, an absorption axis of the material of the polarizer preferably is orientated in the Δn¹ direction.

The iodine based light absorbing material in a matrix is orientated so that an absorption axis of the material may become parallel to the above-mentioned Δn¹ direction, and thereby linearly polarized light in the Δn¹ direction as a scattering polarizing direction may be selectively absorbed. As a result, on one hand, a linearly polarized light component of incident light in a Δn² direction is not scattered or hardly absorbed by the iodine light absorbing material as in conventional iodine based polarizers without anisotropic scattering performance. On the other hand, a linearly polarized light component in the Δn¹ direction is scattered, and is absorbed by the iodine based light absorbing material. Usually, absorption is determined by an absorption coefficient and a thickness. In such a case, scattering of light greatly lengthens an optical path length compared with a case where scattering is not given. As a result, polarized component in the Δn¹ direction is more absorbed as compared with a case in conventional iodine based polarizers. That is, higher polarization degrees may be attained with same transmittances.

Descriptions for ideal models will, hereinafter, be given. Two main transmittances usually used for linear polarizer (a first main transmittance k₁ (a maximum transmission direction=linearly polarized light transmittance in a Δn² direction), a second main transmittance k₂ (a minimum transmission direction=linearly polarized light transmittance in a Δn¹ direction)) are, hereinafter, used to give discussion.

In commercially available iodine based polarizers, when iodine based light absorbing materials are oriented in one direction, a parallel transmittance and a polarization degree may be represented as follows, respectively:
parallel transmittance=0.5×((k₁)²+(k₂)²) and
polarization degree=(k₁−k₂)/(k₁+k₂).

On the other hand, when it is assumed that, in a polarizer of this invention, a polarized light in a Δn¹ direction is scattered and an average optical path length is increased by a factor of α (>1), and depolarization by scattering may be ignored, main transmittances in this case may be represented as k₁ and k₂′=10^{x} (where, x is α log k₂), respectively

That is, a parallel transmittance in this case and the polarization degree are represented as follows:
parallel transmittance=0.5×((k₁)²+(k₂′)²) and
polarization degree=(k₁−k₂′)/(k₁+k₂′).

When a polarizer of this invention is prepared by a same condition (an amount of dyeing and production procedure are same) as in commercially available iodine based polarizers (parallel transmittance 0.385, polarization degree 0.965: k₁=0.877, k₂=0.016), on calculation, when α is 2 times, k₂ becomes small reaching 0.0003, and as result, a polarization degree improves up to 0.999, while a parallel transmittance is maintained as 0.385. The above-mentioned result is on calculation, and function may decrease a little by effect of depolarization caused by scattering, surface reflection, backscattering, etc. As the above-mentioned equations show, higher value α may give better results and higher dichroic ratio of the iodine based light absorbing material may provide higher function. In order to obtain higher value α, a highest possible scattering anisotropy function may be realized and polarized light in a Δn¹ direction may just be selectively and strongly scattered. Besides, less backscattering is preferable, and a ratio of backscattering strength to incident light strength is preferably 30% or less, and more preferably 20% or less.

As the above-mentioned polarizing plates, the films manufactured by stretching may be suitably used as the polarizer

In the above-mentioned polarizing plate, minute domains of the polarizers preferably have a length in a Δn² direction of 0.05 to 500 μm.

In order to scatter strongly linearly polarized light having a plane of vibration in a Δn¹ direction in wavelengths of visible light band, dispersed minute domains have a length controlled to 0.05 to 500 μm in a Δn² direction, and preferably controlled to 0.5 to 100 μm. When the length in the Δn² direction of the minute domains is too short a compared with wavelengths, scattering may not fully provided. On the other hand, when the length in the Δn² direction of the minute domains is too long, there is a possibility that a problem of decrease in film strength or of liquid crystalline material forming minute domains not fully oriented in the minute domains may arise.

In the above-mentioned polarizing plate, iodine light absorbing materials of the polarizers having an absorption band at least in a wavelength range of 400 to 700 nm may be used.

In the above-mentioned polarizing plate, the protective film preferably include at least one selected from the group of a resin compound that contains a thermoplastic resin (A) having substituted and/or non-substituted imide group in a side chain and a thermoplastic resin (B) having substituted and/or non-substituted phenyl group and nitrile group in a side chain, and a norbornene-based resin. In addition, the protective film including at least one selected from the group of a polyolefin-based resin, a polyester-based resin and a polyamide-based is preferably used. Besides, a cellulose-based resin film to which a specific treatment has been applied may be used.

A protective film made from the above described material can secure a stable retardation even in a case where a polarizer changes in dimension under conditions of a high temperature and a high humidity and receives a stress. That is, retardation is hard to be generated even under conditions of a high temperature and a high humidity, thereby enabling an optical film with a less change in characteristics to be obtained. Especially preferable is a protective film containing a mixture of thermoplastic resins (A) and (B).

In general, stretching a film improves strength of the film, and realizes a more rigid mechanical characteristic to be imparted. Since retardation is generated in many of materials by stretching, however, such materials cannot be used as a material of a protective film for a polarizer. A protective film containing a mixture of the thermoplastic resins (A) and (B) preferably suppresses the in-plane retardation and the thickness direction retardation even in a case where the protective film is stretched. Stretching may be either uniaxial or biaxial. Especially preferable is a biaxial stretched film.

In the above-mentioned polarizing plates, a transmittance to a linearly polarized light in a transmission direction is 80% or more, a haze value is 5% or less, and a haze value to a linearly polarized light in an absorption direction is 30% or more.

The polarizing plate having the above-mentioned transmittance and haze value has a high transmittance and excellent visibility for linearly polarized light in a transmission direction, and has strong optical diffusibility for linearly polarized light in an absorption direction. Therefore, without sacrificing other optical properties and using a simple method, it may demonstrate a high transmittance and a high polarization degree, and may control unevenness of the transmittance in the case of black viewing. That is, in black viewing, unevenness due to local fluctuations in transmittance is hidden by scattering, while in white viewing; a clear image is produced without scattering. In other words, visibility is better and light leakage is lessened when a screen image is observed from the front or obliquely.

As a polarizing plate of this invention, a polarizing plate is preferable that has as high as possible transmittance to linearly polarized light in a transmission direction, that is, linearly polarized light in a direction perpendicular to a direction of maximal absorption of the above-mentioned iodine based light absorbing material, and that has 80% or more of light transmittance when an optical intensity of incident linearly polarized light is set to 100. The light transmittance is preferably 85% or more, and still preferably 88% or more. Here, a light transmittance is equivalent to a value Y calculated from a spectral transmittance in 380 nm to 780 nm measured using a spectrophotometer with an integrating sphere based on CIE 1931 XYZ standard colorimetric system. In addition, since about 8% to 10% is reflected by an air interface on a front surface and rear surface of a polarizer, an ideal limit is a value in which a part for this surface reflection is deducted from 100%.

It is desirable that a polarizing plate does not scatter linearly polarized light in a transmission direction in the view point of obtaining clear visibility of a display image. Accordingly, the polarizer preferably has 5% or less of haze value to the linearly polarized light in the transmission direction, more preferably 3% or less, and still more preferably 1% or less. On the other hand, in the view point of covering unevenness by a local transmittance variation by scattering, a polarizing plate desirably scatters strongly linearly polarized light in a absorption direction, that is, linearly polarized light in a direction for a maximal absorption of the above-mentioned iodine based light absorbing material. Accordingly, a haze value to the linearly polarized light in the absorption direction is preferably 30% or more, more preferably 40% or more, and still more preferably 50% or more. In addition, the haze value here is measured based on JIS K 7136 (how to obtain a haze of plastics-transparent material).

The above-mentioned optical properties are obtained by compounding a function of scattering anisotropy with a function of an absorption dichroism of the polarizer. As is indicated in U.S. Pat. No. 2,123,902 specification, Japanese Patent Laid-Open No.9-274108, and Japanese Patent Laid-Open No.9-297204, same characteristics may probably be attained also in a way that a scattering anisotropic film having a function to selectively scatter only linearly polarized light, and a dichroism absorption type polarizer are superimposed in an axial arrangement so that an axis providing a greatest scattering and an axis providing a greatest absorption may be parallel to each other. These methods, however, require necessity for separate formation of a scattering anisotropic film, have a problem of precision in axial joint in case of superposition, and furthermore, a simple superposition method does not provide increase in effect of the above-mentioned optical path length of the polarized light absorbed as is expected, and as a result, the method cannot easily attain a high transmission and a high polarization degree.

Besides, this invention relates to an optical film characterized by being laminated with at least one of the above-mentioned polarizing plate.

Moreover, this invention relates to an image display characterized by using the above-mentioned polarizing plate or the above-mentioned optical film.

### BRIEF DESCRIPTION OF DRAWING

FIG. 1 is conceptual view showing an example of a polarizer of this invention.

### BEST MODE FOR CARRYING OUT THE INVENTION

A polarizing plate of the present invention is configured such that a protective film is laminated on one side or both sides of a polarizer.

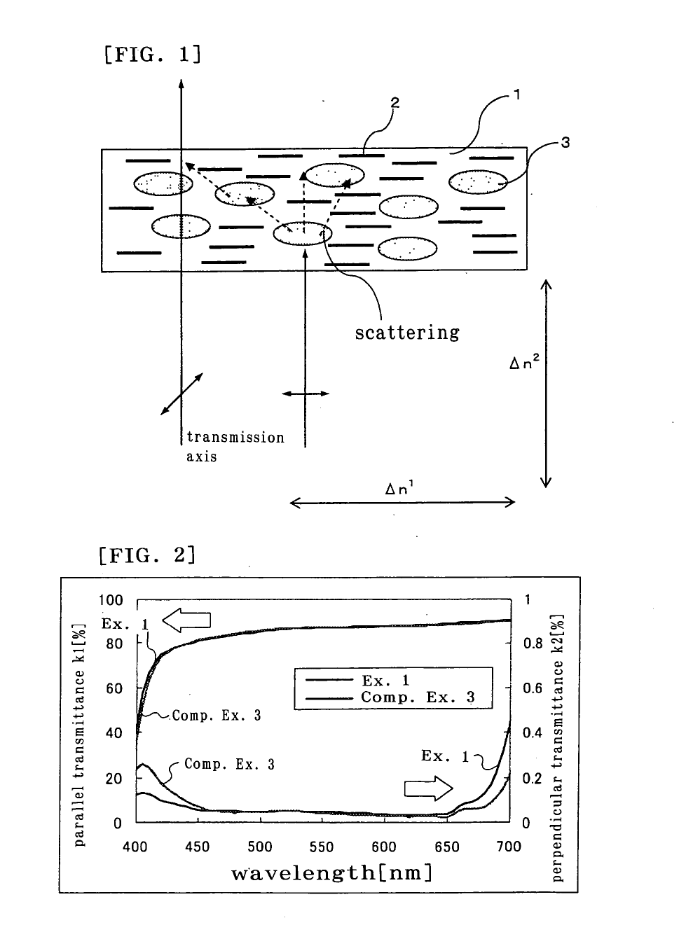

A polarizer of this invention will, hereinafter, be described referring to drawings. FIG. 1 is a conceptual top view of a polarizer of this invention, and the polarizer has a structure where a film is formed with a translucent water-soluble resin 1 including an iodine based light absorbing material 2, and minute domains 3 are dispersed in the film concerned as a matrix.

FIG. 1 shows an example of a case where the iodine based light absorbing material 2 is oriented in a direction of axis (An, direction) in which a refractive index difference between the minute domain 3 and the translucent water-soluble resin 1 shows a maximal value. In minute domain 3, a polarized component in the Δn¹ direction are scattered. In FIG. 1, the Δn¹ direction in one direction in a film plane is an absorption axis. In the film plane, a Δn² direction perpendicular to the Δn¹ direction serves as a transmission axis. Another Δn² direction perpendicular to the Δn¹ direction is a thickness direction.

As translucent water-soluble resins 1, resins having translucency in a visible light band and dispersing and absorbing the iodine based light absorbing materials may be used without particular limitation. For example, polyvinyl alcohols or derivatives thereof conventionally used for polarizers may be mentioned. As derivatives of polyvinyl alcohol, polyvinyl formals, polyvinyl acetals, etc. may be mentioned, and in addition derivatives modified with olefins, such as ethylene and propylene, and unsaturated carboxylic acids, such as acrylic acid, methacrylic acid, and crotonic acid, alkyl esters of unsaturated carboxylic acids, acrylamides etc. may be mentioned. Besides, as translucent water-soluble resin 1, for example, polyvinyl pyrrolidone based resins, amylose based resins, etc. may be mentioned. The above-mentioned translucent water-soluble resin may be of resins having isotropy not easily generating orientation birefringence caused by molding deformation etc., and of resins having anisotropy easily generating orientation birefringence.

In materials forming minute domains 3, it is not limited whether the material has birefringence or isotropy, but materials having birefringence is particularly preferable. Moreover, as materials having birefringence, materials (henceforth, referred to as liquid crystalline material) showing liquid crystallinity at least at the time of orientation treatment may preferably used. That is, the liquid crystalline material may show or may lose liquid crystallinity in the formed minute domain 3, as long as it shows liquid crystallinity at the orientation treatment time.

As materials forming minute domains 3, materials having birefringences (liquid crystalline materials) may be any of materials showing nematic liquid crystallinity, smectic liquid crystallinity, and cholesteric liquid crystallinity, or of materials showing lyotropic liquid crystallinity. Moreover, materials having birefringence may be of liquid crystalline thermoplastic resins, and may be formed by polymerization of liquid crystalline monomers. When the liquid crystalline material is of liquid crystalline thermoplastic resins, in the view point of heat-resistance of structures finally obtained, resins with high glass transition temperatures may be preferable. Furthermore, it is preferable to use materials showing glass state at least at room temperatures. Usually, a liquid crystalline thermoplastic resin is oriented by heating, subsequently cooled to be fixed, and forms minute domains 3 while liquid crystallinity are maintained. Although liquid crystalline monomers after orienting can form minute domains 3 in the state of fixed by polymerization, cross-linking, etc., some of the formed minute domains 3 may lose liquid crystallinity.

As the above-mentioned liquid crystalline thermoplastic resins, polymers having various skeletons of principal chain types, side chain types, or compounded types thereof may be used without particular limitation. As principal chain type liquid crystal polymers, polymers, such as condensed polymers having structures where mesogen groups including aromatic units etc. are combined, for example, polyester based, polyamide based, polycarbonate based, and polyester imide based polymers, may be mentioned. As the above-mentioned aromatic units used as mesogen groups, phenyl based, biphenyl based, and naphthalene based units may be mentioned, and the aromatic units may have substituents, such as cyano groups, alkyl groups, alkoxy groups, and halogen groups.

As side chain type liquid crystal polymers, polymers having principal chain of, such as polyacrylate based, polymethacrylate based, poly-alpha-halo acrylate based, poly-alpha-halo cyano acrylate based, polyacrylamide based, polysiloxane based, and poly malonate based principal chain as a skeleton, and having mesogen groups including cyclic units etc. in side chains may be mentioned. As the above-mentioned cyclic units used as mesogen groups, biphenyl based, phenyl benzoate based, phenylcyclohexane based, azoxybenzene based, azomethine based, azobenzene based, phenyl pyrimidine based, diphenyl acetylene based, diphenyl benzoate based, bicyclo hexane based, cyclohexylbenzene based, terphenyl based units, etc. may be mentioned. Terminal groups of these cyclic units may have substituents, such as cyano group, alkyl group, alkenyl group, alkoxy group, halogen group, haloalkyl group, haloalkoxy group, and haloalkenyl group. Groups having halogen groups may be used for phenyl groups of mesogen groups.

Besides, any mesogen groups of the liquid crystal polymer may be bonded via a spacer part giving flexibility. As spacer parts, polymethylene chain, polyoxymethylene chain, etc. may be mentioned. A number of repetitions of structural units forming the spacer parts is suitably determined by chemical structure of mesogen parts, and the number of repeating units of polymethylene chain is 0 to 20, preferably 2 to 12, and the number of repeating units of polyoxymethylene chain is 0 to 10, and preferably 1 to 3.

The above-mentioned liquid crystalline thermoplastic resins preferably have glass transition temperatures of 50° C. or more, and more preferably 80° C. or more. Furthermore they have approximately 2,000 to 100,000 of weight average molecular weight.

As liquid crystalline monomers, monomers having polymerizable functional groups, such as acryloyl groups and methacryloyl groups, at terminal groups, and further having mesogen groups and spacer parts including the above-mentioned cyclic units etc. may be mentioned. Crossed-linked structures may be introduced using polymerizable functional groups having two or more acryloyl groups, methacryloyl groups, etc., and durability may also be improved.

Materials forming minute domains 3 are not entirely limited to the above-mentioned liquid crystalline materials, and non-liquid crystalline resins may be used if they are different materials from the matrix materials. As the above-mentioned resins, polyvinyl alcohols and derivatives thereof, polyolefins, polyarylates, polymethacrylates, polyacrylamides, polyethylene terephthalates, acrylic styrene copolymes, etc. may be mentioned. Moreover, particles without birefringence may be used as materials for forming the minute domains 3. As fine-particles concerned, resins, such as polyacrylates and acrylic styrene copolymers, may be mentioned. A size of the fine-particles is not especially limited, and particle diameters of 0.05 to 500 μm may be used, and preferably 0.5 to 100 μm. Although it is preferable that materials for forming minute domains 3 is of the above-mentioned liquid crystalline materials, non-liquid crystalline materials may be mixed and used to the above-mentioned liquid crystalline materials. Furthermore, as materials for forming minute domains 3, non-liquid crystalline materials may also be independently used.

In a polarizer of this invention, while producing a film in which a matrix is formed with a translucent water-soluble resin 1 including an iodine based light absorbing material 2, minute domains 3 (for example, an oriented birefringent material formed with liquid crystalline materials) are dispersed in the matrix concerned. Moreover, the above-mentioned refractive index difference (Δn¹) in a Δn¹ direction and a refractive index difference (Δn²) in a Δn² direction are controlled to be in the above-mentioned range in the film.

Manufacturing process of a polarizer of this invention is not especially limited, and for example, the polarizer of this invention may be obtained using following production processes:
(1) a process for manufacturing a mixed solution in which a material for forming minute domains is dispersed in a translucent water-soluble resin forming a matrix (description is, hereinafter, to be provided, with reference to an example of representation, for a case where a liquid crystalline material is used as a material forming the minute domains. A case by a liquid crystalline material will apply to a case by other materials.);
(2) a process in which a film is formed with the mixed solution of the above-mentioned (1);
(3) a process in which the film obtained in the above-mentioned (2) is oriented (stretched); and
(4) a process in which an iodine based light absorbing material is dispersed (dyed) in the translucent water-soluble resin forming the above-mentioned matrix.
   In addition, an order of the processes (1) to (4) may suitably be determined.

In the above-mentioned process (1), a mixed solution is firstly prepared in which a liquid crystalline material forming minute domains is dispersed in a translucent water-soluble resin forming a matrix. A method for preparing the mixed solution concerned is not especially limited, and a method may be mentioned of utilizing a phase separation phenomenon between the above-mentioned matrix component (a translucent water-soluble resin) and a liquid crystalline material. For example, a method may be mentioned in which a material having poor compatibility between the matrix component as a liquid crystalline material is selected, a solution of the material forming the liquid crystalline material is dispersed using dispersing agents, such as a surface active agent, in a water solution of the matrix component. In preparation of the above-mentioned mixed solution, some of combinations of the translucent material forming the matrix, and the liquid crystal material forming minute domains do not require a dispersing agent. An amount used of the liquid crystalline material dispersed in the matrix is not especially limited, and a liquid crystalline material is 0.01 to 100 parts by weight to a translucent water-soluble resin 100 parts by weight, and preferably it is 0.1 to 10 parts by weight. The liquid crystalline material is used in a state dissolved or not dissolved in a solvent. Examples of solvents, for example, include: water, toluene, xylene, hexane cyclohexane, dichloromethane, trichloromethane, dichloroethane, trichloroethane, tetrachloroethane, trichloroethylene, methyl ethyl ketone, methylisobutylketone, cyclohexanone, cyclopentanone, tetrahydrofuran, ethyl acetate, etc. Solvents for the matrix components and solvents for the liquid crystalline materials may be of same, or may be of different solvents.

In the above-mentioned process (2), in order to reduce foaming in a drying process after a film formation, it is desirable that solvents for dissolving the liquid crystalline material forming a minute domains is not used in preparation of the mixed solution in the process (1). When solvents are not used, for example, a method may be mentioned in which a liquid crystalline material is directly added to an aqueous solution of a translucency material forming a matrix, and then is heated above a liquid crystal temperature range in order to disperse the liquid crystalline material uniformly in a smaller state.

In addition, a solution of a matrix component, a solution of a liquid crystalline material, or a mixed solution may include various kinds of additives, such as dispersing agents, surface active agents, ultraviolet absorption agents, flame retardants, antioxidants, plasticizers, mold lubricants, other lubricants, and colorants in a range not disturbing an object of this invention.

In the process (2) for obtaining a film of the above-mentioned mixed solution, the above-mentioned mixed solution is heated and dried to remove solvents, and thus a film with minute domains dispersed in the matrix is produced. As methods for formation of the film, various kinds of methods, such as casting methods, extrusion methods, injection molding methods, roll molding methods, and flow casting molding methods, may be adopted. In film molding, a size of minute domains in the film is controlled to be in a range of 0.05 to 500 μm in a Δn² direction. Sizes and dispersibility of the minute domains may be controlled, by adjusting a viscosity of the mixed solution, selection and combination of the solvent of the mixed solution, dispersant, and thermal processes (cooling rate) of the mixed solvent and a rate of drying. For example, a mixed solution of a translucent water-soluble resin that has a high viscosity and generates high shearing force and that forms a matrix, and a liquid crystalline material forming minute domains is dispersed by agitators, such as a homogeneous mixer, being heated at a temperature in no less than a range of a liquid crystal temperature, and thereby minute domains may be dispersed in a smaller state.

The process (3) giving orientation to the above-mentioned film may be performed by stretching the film. In stretching, uniaxial stretching, biaxial stretching, diagonal stretching are exemplified, but uniaxial stretching is usually performed. Any of dries type stretching in air and wet type stretching in an aqueous system bath may be adopted as the stretching method. When adopting a wet type stretching, an aqueous system bath may include suitable additives (boron compounds, such as boric acid; iodide of alkali metal, etc.) A stretching ratio is not especially limited, and in usual a ratio of approximately 2 to 10 times is preferably adopted.

This stretching may orient the iodine based light absorbing material in a direction of stretching axis. Moreover, the liquid crystalline material forming a birefringent material is oriented in the stretching direction in minute domains by the above-mentioned stretching, and as a result birefringence is demonstrated.

It is desirable the minute domains may be deformed according to stretching. When minute domains are of non-liquid crystalline materials, approximate temperatures of glass transition temperatures of the resins are desirably selected as stretching temperatures, and when the minute domains are of liquid crystalline materials, temperatures making the liquid crystalline materials exist in a liquid crystal state such as nematic phase or smectic phase or an isotropic phase state, are desirably selected as stretching temperatures. When inadequate orientation is given by stretching process, processes, such as heating orientation treatment, may separately be added.

In addition to the above-mentioned stretching, function of external fields, such as electric field and magnetic field, may be used for orientation of the liquid crystalline material. Moreover, liquid crystalline materials mixed with light reactive substances, such as azobenzene, and liquid crystalline materials having light reactive groups, such as a cinnamoyl group, introduced thereto are used, and thereby these materials may be oriented by orientation processing with light irradiation etc. Furthermore, a stretching processing and the above-mentioned orientation processing may also be used in combination. When the liquid crystalline material is of liquid crystalline thermoplastic resins, it is oriented at the time of stretching, cooled at room temperatures, and thereby orientation is fixed and stabilized. Since target optical property will be demonstrated if orientation is carried out, the liquid crystalline monomer may not necessarily be in a cured state. However, in liquid crystalline monomers having low isotropic transition temperatures, a few temperature rise provides an isotropic state. In such a case, since anisotropic scattering may not be demonstrated but conversely polarized light performance deteriorates, the liquid crystalline monomers are preferably cured. Besides, many of liquid crystalline monomers will be crystallized when left at room temperatures, and then they will demonstrate anisotropic scattering and polarized light performance conversely deteriorate, the liquid crystalline monomers are preferably cured. In the view point of these phenomena, in order to make orientation state stably exist under any kind of conditions, liquid crystalline monomers are preferably cured. In curing of a liquid crystalline monomer, for example, after the liquid crystalline monomer is mixed with photopolymerization initiators, dispersed in a solution of a matrix component and oriented, in either of timing (before dyed or after dyed by iodine based light absorbing materials), the liquid crystalline monomer is cured by exposure with ultraviolet radiation etc. to stabilize orientation. Desirably, the liquid crystalline monomer is cured before dyed with iodine based light absorbing materials.

As a process (4) in which the iodine based light absorbing material is dispersed in the translucent water-soluble resin used for forming the above-mentioned matrix, in general, a method in which the above-mentioned film is immersed into a bath of aqueous system including iodine dissolved with auxiliary agents of iodide of alkali metals, such as potassium iodide may be mentioned. As mentioned above, an iodine based light absorbing material is formed by interaction between iodine dispersed in the matrix and the matrix resin. Timing of immersing may be before or after the above-mentioned stretching process (3). The iodine based light absorbing material is, in general, remarkably formed by being passed through a stretching process. A concentration of the aqueous system bath including iodine, and a proportion of the auxiliary agents, such as iodide of alkali metals may not especially be limited, but general iodine dyeing techniques may be adopted, and the above-mentioned concentration etc. may arbitrarily be changed.

Moreover, a proportion of the iodine in the polarizer obtained is not especially limited, but a proportion of the translucent water-soluble resin and the iodine is preferably controlled to be 0.05 to 50 parts by weight grade to the translucent water-soluble resin 100 parts by weight, and more preferably 0.1 to 10 parts by weight.

In production of the polarizer, processes for various purposes (5) may be given other than the above-mentioned processes (1) to (4). As a process (5), for example, a process in which a film is immersed in water bath and swollen may be mentioned for the purpose of mainly improving iodine dyeing efficiency of the film. Besides, a process in which a film is immersed in a water bath including arbitrary additives dissolved therein may be mentioned. A process in which a film is immersed in an aqueous solution including additives, such as boric acid and borax, for the purpose of cross-linking a water-soluble resin (matrix) may be mentioned. Moreover, for the purpose of mainly adjusting an amount balance of the dispersed iodine based light absorbing materials, and adjusting a hue, a process in which a film is immersed to an aqueous solution including additives, such as an iodide of an alkaline metals may be mentioned.

As for the process (3) of orienting (stretching) of the above-mentioned film, the process (4) of dispersing and dyeing the iodine based light absorbing material to a matrix resin and the above-mentioned process (5), so long as each of the processes (3) and (4) is provided at least 1 time, respectively, a number, order and conditions (a bath temperature, immersion period of time, etc.) of the processes, may arbitrarily be selected, each process may separately be performed and furthermore a plurality of processes may simultaneously be performed. For example, a cross-linking process of the process (5) and the stretching process (3) may be carried out simultaneously.

In addition, although the iodine based light absorbing material used for dyeing, boric acid used for cross-linking are permeated into a film by immersing the film in an aqueous solution as mentioned above, instead of this method, a method may be adopted that arbitrary types and amounts may be added before film formation of the process (2) and before or after preparation of a mixed solution in the process (1). And both methods may be used in combination. However, when high temperatures (for example, no less than 80° C.) is required in the process (3) at the time of stretching etc., in the view point of heat resistance of the iodine based light absorbing material, the process (4) for dispersing and dyeing the iodine based light absorbing material may be desirably performed after the process (3).

A film given the above treatments is desirably dried using suitable conditions. Drying is performed according to conventional methods.

A thickness of the obtained polarizer (film) is not especially limited, in general, but it is 1 μm to 3 mm, preferably 5 μm to 1 mm, and more preferably 10 to 500 μm.

A polarizer obtained in this way does not especially have a relationship in size between a refractive index of the birefringent material forming minute domains and a refractive index of the matrix resin in a stretching direction, whose stretching direction is in a Δn¹ direction and two directions perpendicular to a stretching axis are Δn² directions. Moreover, the stretching direction of an iodine based light absorbing material is in a direction demonstrating maximal absorption, and thus a polarizer having a maximally demonstrated effect of absorption and scattering may be realized.

A protective film used satisfies an in-plane retardation, which is expressed by Re=(nx−ny) x d, of 20 nm or less, and a thickness direction retardation, which is expressed by Rth={(nx+ny)/231 nz} x d, of 30 nm or less,

where the direction along with the refractive index in the film plane is maximum is defined as the X-axis, a direction perpendicular to the X-axis as the Y-axis, the thickness direction of the film as the Z-axis, and where refractive indices in each axial direction are defined as nx, ny, and nz, respectively, and the thickness of the film as d (nm).

As a materials of the protective film include a resin compound that contains a thermoplastic resin (A) having substituted and/or non-substituted imide group in a side chain and a thermoplastic resin (B) having substituted and/or non-substituted phenyl group and nitrile group in a side chain, and a norbornene-based resin. Further, a polyolefin-based resin, a polester-based resin, a polyamide-based resin, and a polyacrylic resin, that satisfy conditions required by the present invention are also included. In addition, a cellulose-based resin film to which a specific treatment is applied may be used.

A protective film comprising the thermoplastic resins (A) and (B) hardly gives retardation, when the film is affected by a stress caused by dimensional variation of the polarizer, and consequently, when stretching processing is given, an in-plane retardation Re and a thickness direction retardation Rth can be controlled small. Protective films comprising the thermoplastic resins (A) and (B) are described in, for example, WO 01/37007. In addition, the protective film may also comprise other resins, when it comprises thermoplastic resins (A) and (B) as principal components.

The thermoplastic resin (A) has substituted and/or non-substituted imide group in a side chain, and a principal chain may be of arbitrary thermoplastic resins. The principal chain may be, for example, of a principal chain consisting only of carbon-atoms, or otherwise atoms other than carbon atoms may also be inserted between carbon atoms. And it may also comprise atoms other than carbon atoms. The principal chain is preferably of hydrocarbons or of substitution products thereof. The principal chain may be, for example, obtained by an addition polymerization. Among concrete examples are polyolefins and polyvinyls. And the principal chain may also be obtained by a condensation polymerization. It may be obtained by, for example, ester bonds, amide bonds, etc. The principal chain is preferably of polyvinyl skeletons obtained by polymerization of substituted vinyl monomers.

As methods for introducing substituted and/or non-substituted imide group into the thermoplastic resin (A), well-known conventional and arbitrary methods may be employed. As examples for those methods, there may be mentioned a method in which monomers having the above-mentioned imide group are polymerized, a method in which the above-mentioned imide group is introduced after a principal chain is formed by polymerization of various monomers, and a method in which compounds having the above-mentioned imide group is grafted to a side chain. As substituents for imide group, well-known conventional substituents that can substitute a hydrogen atom of the imide group may be used. For example, alkyl groups, etc. may be mentioned as examples.

The thermoplastic resin (A) is preferably of two or more component copolymers including a repeating unit induced from at least one kind of olefin, and a repeating unit having at least one kind of substituted and/or non-substituted maleimide structure. The above-mentioned olefin-maleimide copolymers may be synthesized from olefins and maleimide compounds using well-known methods. The synthetic process is described in, for example, Japanese Patent Laid-Open Publication No.H5-59193, Japanese Patent Laid-Open Publication No.H5-195801, Japanese Patent Laid-Open Publication No.H6-136058, and Japanese Patent Laid-Open Publication No.H9-328523 official gazettes.

As olefins, for example, there may be mentioned, isobutene, 2-methyl-1-butene, 2-methyl-1-pentene, 2-methyl-1-hexene, 2-methyl-1-heptene, 1-iso octene, 2-methyl-1-octene, 2-ethyl-1-pentene, 2-ethyl-2-butene, 2-methyl-2-pentene, and 2-methyl-2-hexene etc. Among them, isobutene is preferable. These olefins may be used independently and two or more kinds may be used in combination.

As maleimide compounds, there may be mentioned, maleimide, N-methyl maleimide, N-ethylmaleimide, N-n-propyl maleimide, N-i-propyl maleimide, N-n-butyl maleimide, N-s-butyl maleimide, N-t-butyl maleimide, N-n-pentyl maleimide, N-n-hexyl maleimide, N-n-heptyl maleimide, N-n-octyl maleimide, N-lauryl maleimide, N-stearyl maleimide, N-cyclo propyl maleimide, N-cyclobutyl maleimide, N-cyclopentyl maleimide, N-cyclohexyl maleimide, N-cycloheptyl maleimide, and N-cyclooctyl maleimide, etc. Among them N-methyl maleimide is preferable. These maleimide compounds may be used independently and two or more kinds may be used in combination.

A content of repeating units of olefin in the olefin-maleimide copolymer is not especially limited, and it is approximately 20 to 70 mole % in all of repeating units in the thermoplastic resin (A), preferably 40 to 60 mole %, and more preferably 45 to 55 mole %. A content of repeating units of maleimide structure is approximately 30 to 80 mole %, preferably 40 to 60 mole %, and more preferably 45 to 55 mole %.

The thermoplastic resin (A) may comprise repeating units of the above-mentioned olefin, and repeating units of maleimide structure, and it may be formed only of these units. And in addition to the above constitution, other vinyl based monomeric repeating units may be included at a proportion of 50 mole % or less. As other vinyl based monomers, there may be mentioned, acrylic acid based monomers, such as methyl acrylate and butyl acrylate; methacrylic acid based monomers, such as methyl methacrylate and cyclo hexyl methacrylate; vinyl ester monomers, such as vinyl acetate; vinyl ether monomers, such as methyl vinyl ether; acid anhydrides, such as maleic anhydride; styrene based monomers, such as styrene, α-methyl styrene, and p-methoxy styrene etc.

A weight average molecular weight of the thermoplastic resin (A) is not especially limited, and it is approximately 1×10³ to 5×10⁶. The above-mentioned weight average molecular weight is preferably 1×10⁴ or more and 5×10⁵ or more. A glass transition temperature of the thermoplastic resin (A) is 80° C. or more, preferably 100° C. or more, and more preferably 130° C. or more.

And glutar imide based thermoplastic resins may be used as the thermoplastic resin (A). Glutar imide based resins are described in Japanese Patent Laid-Open Publication No.H2-153904 etc. Glutar imide based resins have glutar imide structural units and methyl acrylate or methyl methacrylate structural units. The above-mentioned other vinyl based monomers may be introduced also into the glutar imide based resins.

The thermoplastic resin (B) is a thermoplastic resin having substituted and/or non-substituted phenyl group, and nitrile group in a side chain. As a principal chain of the thermoplastic resin (B), similar principal chains as of the thermoplastic resin (A) may be illustrated.

As a method of introducing the above-mentioned phenyl group into the thermoplastic resin (B), for example, there may be mentioned a method in which monomers having the above-mentioned phenyl group is polymerized, a method in which phenyl group is introduced after various monomers are polymerized to form a principal chain, and a method in which compounds having phenyl group are grafted into a side chain, etc. As substituents for phenyl group, well-known conventional substituents that can substitute a hydrogen atom of the phenyl group may be used. For example, alkyl groups, etc. may be mentioned as examples. As method for introducing nitrile groups into the thermoplastic resin (B), similar methods for introducing phenyl groups may be adopted.

The thermoplastic resin (B) is preferably of two or more components copolymers comprising repeating unit (nitrile unit) induced from unsaturated nitrile compounds, and repeating unit (styrene based unit) induced from styrene based compounds. For example, acrylonitrile styrene based copolymers may preferably be used.

As unsaturated nitrile compounds, arbitrary compounds having cyano groups and reactive double bonds may be mentioned.

For example, acrylonitrile, α-substituted unsaturated nitrites, such as methacrylonitrile, nitrile compounds having has α- and β-disubstituted olefin based unsaturated bond, such as fumaronitrile may be mentioned.

As styrene based compound, arbitrary compounds having a phenyl group and a reactive double bond may be mentioned. For example, there may be mentioned, non-substituted or substituted styrene based compounds, such as styrene, vinyltoluene, methoxy styrene, and chloro styrene; α-substituted styrene based compounds, such as α-methyl styrene.

A content of a nitrile unit in the thermoplastic resin (B) is not especially limited, and it is approximately 10 to 70% by weight on the basis of all repeating units, preferably 20 to 60% by weight, and more preferably 20 to 50% by weight. It is further preferably 20 to 40% by weight, and still further preferably 20 to 30% by weight. A content of a styrene based unit is approximately 30 to 80% by weight, preferably 40 to 80% by weight, and more preferably 50 to 80% by weight. It is especially 60 to 80% by weight, and further preferably 70 to 80% by weight.

The thermoplastic resin (B) comprises repeating units of the above-mentioned nitrites, and styrene based repeating units, and it may be formed only of these units. And in addition to the above constitution, other vinyl based monomeric repeating units may be included at a proportion of 50 mole % or less. As other vinyl based monomers, compounds, repeating units of olefins, repeating units of maleimide and substituted maleimides, etc. may be mentioned, which were illustrated in the case of thermoplastic resin (A). As the thermoplastic resins (B), AS resins, ABS resins, ASA resins, etc. may be mentioned.

A weight average molecular weight of the thermoplastic resin (B) is not especially limited, and it is approximately 1×10³ to 5×10⁶. It is preferably 1×10⁴ or more, and 5×10⁵ or less.

A compounding ratio of the thermoplastic resin (A) and the thermoplastic resin (B) is adjusted depending on a retardation required for a protective film. In the above-mentioned compounding ratio, in general, a content of the thermoplastic resin (A) is preferably 50 to 95% by weight in total amount of a resin in a film, more preferably 60 to 95% by weight, and still more preferably 65 to 90% by weight. A content of the thermoplastic resin (B) is preferably 5 to 50% by weight in total amount of the resin in the film, more preferably 5 to 40% by weight, and still more preferably 10 to 35% by weight. The thermoplastic resin (A) and the thermoplastic resin (B) are mixed using a method in which these are kneaded in thermally molten state.

Examples of norbornene-based resins include, for example, a resin obtained by hydrogenation of a ring opening (co)polymer, which is subjected to modification such as a maleic acid addition or a cyclopentadiene addition if necessary, of a norbornene-based monomer; a resin obtained by addition polymerization of a norbornene-based monomer; a resin obtained by addition polymerization of a norbornene-based monomer; a resin obtained by addition polymerization of a norbornene-based monomer with an olefin-based monomer such as ethylene or α-olefin; and a resin obtained by addition polymerization of a norbornene-based monomer with a cycloolefin-based monomer such as a cyclopentene, cyclooctene, 5,6-dihydrodicyclopentadiene or the like. Specifically, examples of thermoplastic saturated norbornene-based resin include ZEONEX and ZENOA manufactured by Nippon Zeon Co., Ltd. and Arton manufactured by JSR Co., Ltd.

Examples of the polyolefin-based resin include: polyethylene, polypropylene, ethylene-propylene copolymer and a homopolymer or a copolymer of α-olefin having 1 to 6 carbon atoms such as poly 4-methylpentene-1. Examples of polyester-based resin include:

polyethylene terephthalate, polyethylene naphthalate, polybutylene terephthalate, polyethylene terephthalate-isophthalate copolymer, and others. In addition, various kinds of polyamide-based resin can be exemplified.

Moreover, a cellulose-based resin to which a specific treatment has been applied can be used. Materials of the cellulose-based resin film include, for example, a fatty acid substituted cellulose-based polymer such as diacetyl cellulose and triacetyl cellulose. A treatment for a cellulose-based resin film can be conducted by such methods as follows. A method in which a base material such as polyethylene terephthalate, polypropylene, stainless or the like to which a solvent such as cyclopentanone or methyl ethyl ketone is applied is adhered to a common cellulose-based resin film, and then heated and dried (at a temperature in the range of about 80 to about 150° C. for a time in the range of from about 3 to about 10 minutes), thereafter a film as the base material is peeled off; and a method in which a solution obtained by dissolving a norbornene-based resin or an acrylic-based resin into a solvent such as cyclopentanone or methyl ethyl ketone is applied to a common cellulose-based resin film, and then heated and dried (at a temperature in the range of about 80 to about 150° C. for a time in the range of from about 3 to about 10 minutes) and thereafter the coated film is peeled off. A cellulose-based resin film can be a fatty acid substituted cellulose-based polymer having a controlled fatty acid substitution degree. Generally used is a triacetyl cellulose with an acetic acid substitution degree of about of 2.8 but a thickness direction retardation (Rth) can be controlled to be a small value by using a cellulose-based polymer with a controlled acetic acid substitution degree in the range of 1.8 to 2.7 and with a controlled propionic acid substitution degree in the range of from 0.1 to 1. Moreover, a thickness direction retardation (Rth) is controlled to be a small value by adding a plasticizer such as dibutyl phthalate, p-toluenesulfonanilide, acetyl triethyl citrate or the like to a fatty acid substituted cellulose-based polymer. A mixing quantity of a plasticizer is preferably about 40 parts by weight or less, more preferably in the range of from 1 to 20 parts by weight and further more preferably in the range of from 1 to 15 parts by weight relative to 100 parts by weight of a fatty acid substituted cellulose-based polymer.

The thickness of a protective film is arbitrary but generally preferably in the range of from 1 to 500 μm and more preferably in the range of from 1 to 300 μm and especially preferably in the range of from 5 to 300 μm in order to use in a thinner polarizing plate. In a case where protective films are provided on both sides bf a polarizer, the protective films can be a combination of protective films made from respective polymers different in kind between the front and back sides.

A water-vapor permeability of a protective film is not specifically limited, but a water-vapor permeability is preferably 500 g/m²/24 h or less and more preferably 120 g/m²/24 h or less. A protective film with a water-vapor permeability of 500 g/m²/24 h or less is good in durability under conditions of high temperature and high humidity and excellent in moisture resistance of a hue. A material from which a protective film is made is preferably a norbornene-based resin because of a low water-vapor permeability.

Various kinds of resin layers can be disposed on a protective film and the protective film may be adhered to a polarizer using an adhesive with the resin layer interposed therebetween.

No specific limitation is imposed on the resin layer as far as it is adhered to a protective film in a good state. Examples of resins that can be used include an ester type resin, an ether type resin, a carbonate type resin, a urethane type resin, a silicone type resin. A resin described above may be either an aqueous type or a solvent type. Preferable among the above examples are an aqueous urethane type resin and an aqueous silicone type resin. A coupling agent such as a silane coupling agent or a titanium coupling agent, and a catalyst such as a titanium based catalyst or a tin-based catalyst used for an efficient reaction of the coupling agent can be added into a resin from which a resin layer described above is made. Thereby, an adhesive strength between a polarizer and a protective film can be more strengthened. Other additives may also be added into a resin layer described above. To be more concrete, examples thereof may include: tackifiers such as a terpene resin, a phenol resin, a terpene-phenol resin, a-rosin resin and a xylene resin; and stabilizers such as an ultraviolet absorbent, an antioxidant and a heat resistance stabilizer.

The layer described above can be formed by coating a solution with a proper concentration diluted in consideration of a thickness after drying, smoothness in coating and the like and drying the wet coat according to a known technique. A thickness after drying of the resin layer is preferably in the range of from 0.01 to 10 μm and more preferably in the range of from 0.1 to 2 μm. In a case where plural resin layers are provided as well, a total thickness of the plural resin layers is preferably in the range.

Note that a side of a polarizer to which a protective film is adhered can be applied with an easy adhesion treatment thereon, in addition to the resin layer to be provided. Examples of the easy adhesion treatment include a dry treatment such as a plasma treatment, a corona treatment, a chemical treatment such as an alkali treatment and a coating treatment forming an easy adhesive layer.

A hard coat layer may be prepared, or antireflection processing, processing aiming at sticking prevention, diffusion or anti glare may be performed onto the face on which the polarizing film of the above described protective film has not been adhered.

A hard coat processing is applied for the purpose of protecting the surface of the polarizing plate from damage, and this hard coat film may be formed by a method in which, for example, a curable coated film with excellent hardness, slide property etc. is added on the surface of the protective film using suitable ultraviolet curable type resins, such as acrylic type and silicone type resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight parts to the transparent resin 100 weight parts that forms the fine concavo-convex structure on the surface, and preferably 5 to 25 weight parts. An anti glare layer may serve as a diffusion layer (viewing angle expanding function etc.) for diffusing transmitting light through the polarizing plate and expanding a viewing angle etc.

In addition, the above-mentioned antireflection layer, sticking prevention layer, diffusion layer, anti glare layer, etc. may be built in the protective film itself, and also they may be prepared as an optical layer different from the protective layer.

Adhesives are used for adhesion processing of the above described polarizing film and the protective film. As adhesives, isocyanate derived adhesives, polyvinyl alcohol derived adhesives, gelatin derived adhesives, vinyl polymers derived latex type, aqueous polyesters derived adhesives, etc. may be mentioned. The above-described adhesives are usually used as adhesives comprising aqueous solution, and usually contain solid of 0.5 to 60% by weight.

A polarizing plate of the present invention is manufactured by adhering the above described protective film and the polarizing film using the above described adhesives. The application of adhesives may be performed to any of the protective film or the polarizing film, and may be performed to both of them. After adhered, drying process is given and the adhesion layer comprising applied dry layer is formed. Adhering process of the polarizing film and the protective film may be performed using a roll laminator etc. Although a thickness of the adhesion layer is not especially limited, it is usually approximately 0.1 to 5 μm.

A polarizing plate of the present invention may be used in practical use as an optical film laminated with other optical layers. Although there is especially no limitation about the optical layers, one layer or two layers or more of optical layers, which may be used for formation of a liquid crystal display etc., such as a reflector, a transflective plate, a retardation plate (a half wavelength plate and a quarter wavelength plate included), and a viewing angle compensation film, may be used. Especially preferable polarizing plates are; a reflection type polarizing plate or a transflective type polarizing plate in which a reflector or a transflective reflector is further laminated onto a polarizing plate of the present invention; an elliptically polarizing plate or a circular polarizing plate in which a retardation plate is further laminated onto the polarizing plate; a wide viewing angle polarizing plate in which a viewing angle compensation film is further laminated onto the polarizing plate; or a polarizing plate in which a brightness enhancement film is further laminated onto the polarizing plate.

A reflective layer is prepared on a polarizing plate to give a reflection type polarizing plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarizing plate may be formed using suitable methods, such as a method in which a reflective layer of metal etc. is, if required, attached to one side of a polarizing plate through a transparent protective layer etc.

As an example of a reflection type polarizing plate, a plate may be mentioned on which, if required, a reflective layer is formed using a method of attaching a foil and vapor deposition film of reflective metals, such as aluminum, to one side of a matte treated protective film. Moreover, a different type of plate with a fine concavo-convex structure on the surface obtained by mixing fine particle into the above-mentioned protective film, on which a reflective layer of concavo-convex structure is prepared, may be mentioned. The reflective layer that has the above-mentioned fine concavo-convex structure diffuses incident light by random reflection to prevent directivity and glaring appearance, and has an advantage of controlling unevenness of light and darkness etc. Moreover, the protective film containing the fine particle has an advantage that unevenness of light and darkness may be controlled more effectively, as a result that an incident light and its reflected light that is transmitted through the film are diffused. A reflective layer with fine concavo-convex structure on the surface effected by a surface fine concavo-convex structure of a protective film may be formed by a method of attaching a metal to the surface of a transparent protective layer directly using, for example, suitable methods of a vacuum evaporation method, such as a vacuum deposition method, an ion plating method, and a sputtering method, and a plating method etc.

Instead of a method in which a reflection plate is directly given to the protective film of the above-mentioned polarizing plate, a reflection plate may also be used as a reflective sheet constituted by preparing a reflective layer on the suitable film for the transparent film. In addition, since a reflective layer is usually made of metal, it is desirable that the reflective side is covered with a protective film or a polarizing plate etc. when used, from a viewpoint of preventing deterioration in reflectance by oxidation, of maintaining an initial reflectance for a long period of time and of avoiding preparation of a protective layer separately etc.

In addition, a transfiective type polarizing plate may be obtained by preparing the above-mentioned reflective layer as a transfiective type reflective layer, such as a half-mirror etc. that reflects and transmits light. A transfiective type polarizing plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transflective type polarizing plate. That is, the transflective type polarizing plate is useful to obtain of a liquid crystal display of the type that saves energy of light sources, such as a back light, in a well-lighted atmosphere, and can be used with a built-in light source if needed in a comparatively dark atmosphere etc.

The above-mentioned polarizing plate may be used as elliptically polarizing plate or circularly polarizing plate on which the retardation plate is laminated. A description of the above-mentioned elliptically polarizing plate or circularly polarizing plate will be made in the following paragraph. These polarizing plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarizing plate is effectively used to give a monochrome display without above-mentioned coloring by compensating (preventing) coloring (blue or yellow color) produced by birefringence of a liquid crystal layer of a super twisted nematic (STN) type liquid crystal display. Furthermore, a polarizing plate in which three-dimensional refractive index is controlled may also preferably compensate (prevent) coloring produced when a screen of a liquid crystal display is viewed from an oblique direction. Circularly polarizing plate is effectively used, for example, when adjusting a color tone of a picture of a reflection type liquid crystal display that provides a colored picture, and it also has function of antireflection. For example, a retardation plate may be used that compensates coloring and viewing angle, etc. caused by birefringence of various wavelength plates or liquid crystal layers etc. Besides, optical characteristics, such as retardation, may be controlled using laminated layer with two or more sorts of retardation plates having suitable retardation value according to each purpose. As retardation plates, birefringence films formed by stretching films comprising suitable polymers, such as polycarbonates, norbornene type resins, polyvinyl alcohols, polystyrenes, poly methyl methacrylates, polypropylene; polyarylates and polyamides; oriented films comprising liquid crystal materials, such as liquid crystal polymer; and films on which an alignment layer of a liquid crystal material is supported may be mentioned. A retardation plate may be a retardation plate that has a proper retardation according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

The above-mentioned elliptically polarizing plate and an above-mentioned reflected type elliptically polarizing plate are laminated plate combining suitably a polarizing plate or a reflection type polarizing plate with a retardation plate. This type of elliptically polarizing plate etc. may be manufactured by combining a polarizing plate (reflected type) and a retardation plate, and by laminating them one by one separately in the manufacture process of a liquid crystal display. On the other hand, the polarizing plate in which lamination was beforehand carried out and was obtained as an optical film, such as an elliptically polarizing plate, is excellent in a stable quality, a workability in lamination etc., and has an advantage in improved manufacturing efficiency of a liquid crystal display.

A viewing angle compensation film is a film for extending viewing angle so that a picture may look comparatively clearly, even when it is viewed from an oblique direction not from vertical direction to a screen. As such a viewing angle compensation retardation plate, in addition, a film having birefringence property that is processed by uniaxial stretching or orthogonal bidirectional stretching and a bidriectionally stretched film as inclined orientation film etc. may be used. As inclined orientation film, for example, a film obtained using a method in which a heat shrinking film is adhered to a polymer film, and then the combined film is heated and stretched or shrunk under a condition of being influenced by a shrinking force, or a film that is oriented in oblique direction may be mentioned. The viewing angle compensation film is suitably combined for the purpose of prevention of coloring caused by change of visible angle based on retardation by liquid crystal cell etc. and of expansion of viewing angle with good visibility.

Besides, a compensation plate in which an optical anisotropy layer consisting of an alignment layer of liquid crystal polymer, especially consisting of an inclined alignment layer of discotic liquid crystal polymer is supported with triacetyl cellulose film may preferably be used from a viewpoint of attaining a wide viewing angle with good visibility.

The polarizing plate with which a polarizing plate and a brightness enhancement film are adhered together is usually used being prepared in a backside of a liquid crystal cell. A brightness enhancement film shows a characteristic that reflects linearly polarized light with a predetermined polarization axis, or circularly polarized light with a predetermined direction, and that transmits other light, when natural light by back lights of a liquid crystal display or by reflection from a back-side etc., comes in. The polarizing plate, which is obtained by laminating a brightness enhancement film to a polarizing plate, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display etc., and as a result luminosity may be improved. That is, in the case where the light enters through a polarizer from backside of a liquid crystal cell by the back light etc. without using a brightness enhancement film, most of the light, with a polarization direction different from the polarization axis of a polarizer, is absorbed by the polarizer, and does not transmit through the polarizer. This means that although influenced with the characteristics of the polarizer used, about 50 percent of light is absorbed by the polarizer, the quantity of the light usable for a liquid crystal picture display etc. decreases so much, and a resulting picture displayed becomes dark. A brightness enhancement film does not enter the light with the polarizing direction absorbed by the polarizer into the polarizer but reflects the light once by the brightness enhancement film, and further makes the light reversed through the reflective layer etc. prepared in the backside to re-enter the light into the brightness enhancement film. By this above-mentioned repeated operation, only when the polarization direction of the light reflected and reversed between the both becomes to have the polarization direction which may pass a polarizer, the brightness enhancement film transmits the light to supply it to the polarizer. As a result, the light from a backlight may be efficiently used for the display of the picture of a liquid crystal display to obtain a bright screen.

A diffusion plate may also be prepared between brightness enhancement film and the above described reflective layer, etc. A polarized light reflected by the brightness enhancement film goes to the above described reflective layer etc., and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided while maintaining brightness of display screen, and simultaneously controlling non-uniformity of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film having a different refractive-index anisotropy; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported may be mentioned.

Therefore, in the brightness enhancement film of a type that transmits a linearly polarized light having the above-mentioned predetermined polarization axis, by arranging the polarization axis of the transmitted light and entering the light into a polarizing plate as it is, the absorption loss by the polarizing plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, taking control an absorption loss into consideration. In addition, a circularly polarized light is convertible into a linearly polarized light using a quarter wavelength plate as the retardation plate.

A retardation plate that works as a quarter wavelength plate in a wide wavelength ranges, such as a visible-light band, is obtained by a method in which a retardation layer working as a quarter wavelength plate to a pale color light with a wavelength of 550 nm is laminated with a retardation layer having other retardation characteristics, such as a retardation layer working as a half-wavelength plate. Therefore, the retardation plate located between a polarizing plate and a brightness enhancement film may consist of one or more retardation layers.

In addition, also-in a cholesteric liquid-crystal layer, a layer reflecting a circularly polarized light in a wide wavelength ranges, such as a visible-light band, may be obtained by adopting a configuration structure in which two or more layers with different reflective wavelength are laminated together. Thus a transmitted circularly polarized light in a wide wavelength range may be obtained using this type of cholesteric liquid-crystal layer.

Moreover, the polarizing plate may consist of multi-layered film of laminated layers of a polarizing plate and two of more of optical layers as the above-mentioned separated type polarizing plate. Therefore, a polarizing plate may be a reflection type elliptically polarizing plate or a semi-transmission type elliptically polarizing plate, etc. in which the above-mentioned reflection type polarizing plate or a transfiective type polarizing plate is combined with above described retardation plate respectively.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as an adhesive layer, may be used for laminating. On the occasion of adhesion of the above described polarizing plate and other optical films, the optical axis may be set as a suitable configuration angle according to the target retardation characteristics etc.

In the polarizing plate mentioned above and the optical film in which at least one layer of the polarizing plate is laminated, an adhesive layer may also be prepared for adhesion with other members, such as a liquid crystal cell etc. As pressure sensitive adhesive that forms adhesive layer is not especially limited, and, for example, acrylic type polymers; silicone type polymers; polyesters, polyurethanes, polyamides, polyethers; fluorine type and rubber type polymers may be suitably selected as a base polymer. Especially, a pressure sensitive adhesive such as acrylics type pressure sensitive adhesives may be preferably used, which is excellent in optical transparency, showing adhesion characteristics with moderate wettability, cohesiveness and adhesive property and has outstanding weather resistance, heat resistance, etc.

Moreover, an adhesive layer with low moisture absorption and excellent heat resistance is desirable. This is because those characteristics are required in order to prevent foaming and peeling-off phenomena by moisture absorption, in order to prevent decrease in optical characteristics and curvature of a liquid crystal cell caused by thermal expansion difference etc. and in order to manufacture a liquid crystal display excellent in durability with high quality.

The adhesive layer may contain additives, for example, such as natural or synthetic resins, adhesive resins, glass fibers, glass beads, metal powder, fillers comprising other inorganic powder etc., pigments, colorants and antioxidants. Moreover, it may be an adhesive layer that contains fine particle and shows optical diffusion nature.

Proper method may be carried out to attach an adhesive layer to one side or both sides of the optical film. As an example, about 10 to 40 weight % of the pressure sensitive adhesive solution in which a base polymer or its composition is dissolved or dispersed, for example, toluene or ethyl acetate or a mixed solvent of these two solvents is prepared. A method in which this solution is directly applied on a polarizing plate top or an optical film top using suitable developing methods, such as flow method and coating method, or a method in which an adhesive layer is once formed on a separator, as mentioned above, and is then transferred on a polarizing plate or an optical film may be mentioned.

An adhesive layer may also be prepared on one side or both sides of a polarizing plate or an optical film as a layer in which pressure sensitive adhesives with different composition or different kind etc. are laminated together. Moreover, when adhesive layers are prepared on both sides, adhesive layers that have different compositions, different kinds or thickness, etc. may also be used on front side and backside of a polarizing plate or an optical film. Thickness of an adhesive layer may be suitably determined depending on a purpose of usage or adhesive strength, etc., and generally is 1 to 500 μm, preferably 5 to 200 μm, and more preferably 10 to 100 μm.

A temporary separator is attached to an exposed side of an adhesive layer to prevent contamination etc., until it is practically used. Thereby, it can be prevented that foreign matter contacts adhesive layer in usual handling. As a separator, without taking the above-mentioned thickness conditions into consideration, for example, suitable conventional sheet materials that is coated, if necessary, with release agents, such as silicone type, long chain alkyl type, fluorine type release agents, and molybdenum sulfide may be used. As a suitable sheet material, plastics films, rubber sheets, papers, cloths, no woven fabrics, nets, foamed sheets and metallic foils or laminated sheets thereof may be used.

In addition, in the present invention, ultraviolet absorbing property may be given to the above-mentioned each layer, such as a polarizer for a polarizing plate, a protective film and an optical film etc. and an adhesive layer, using a method of adding UV absorbents, such as salicylic acid ester type compounds, benzophenol type compounds, benzotriazol type compounds, cyano acrylate type compounds, and nickel complex salt type compounds.

An optical film of the present invention may be preferably used for manufacturing various equipment, such as liquid crystal display, etc. Assembling of a liquid crystal display may be carried out according to conventional methods. That is, a liquid crystal display is generally manufactured by suitably assembling several parts such as a liquid crystal cell, optical films and, if necessity, lighting system, and by incorporating driving circuit. In the present invention, except that an optical film by the present invention is used, there is especially no limitation to use any conventional methods. Also any liquid crystal cell of arbitrary type, such as TN type, and STN type, π type may be used.

Suitable liquid crystal displays, such as liquid crystal display with which the above-mentioned optical film has been located at one side or both sides of the liquid crystal cell, and with which a backlight or a reflector is used for a lighting system may be manufactured. In this case, the optical film by the present invention may be installed in one side or both sides of the liquid crystal cell. When installing the optical films in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display) will be explained. Generally, in organic EL display, a transparent electrode, an organic luminescence layer and a metal electrode are laminated on a transparent substrate in an order configuring an illuminant (organic electro luminescence illuminant). Here, an organic luminescence layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

An organic EL display emits light based on a principle that positive hole and electron are injected into an organic luminescence layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in a intermediate process is the same as a mechanism in common diodes, and, as is expected, there is a strong non-linear relationship between electric current and luminescence strength accompanied by rectification nature to applied voltage.

In an organic EL display, in order to take out luminescence in an organic luminescence layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display of such a configuration, an organic luminescence layer is formed by a very thin film about 10 nm in thickness. For this reason, light is transmitted nearly completely through organic luminescence layer as through transparent electrode. Consequently, since the light that enters, when light is not emitted, as incident light from a surface of a transparent substrate and is transmitted through a transparent electrode and an organic luminescence layer and then is reflected by a metal electrode, appears in front surface side of the transparent substrate again, a display side of the organic EL display looks like mirror if viewed from outside.

In an organic EL display containing an organic electro luminescence illuminant equipped with a transparent electrode on a surface side of an organic luminescence layer that emits light by impression of voltage, and at the same time equipped with a metal electrode on a back side of organic luminescence layer, a retardation plate may be installed between these transparent electrodes and a polarizing plate, while preparing the polarizing plate on the surface side of the transparent electrode.

Since the retardation plate and the polarizing plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarizing plate and the retardation plate is adjusted to π/4, the mirror surface of the metal electrode may be completely covered.

This means that only linearly polarized light component of the external light that enters as incident light into this organic EL display is transmitted with the work of polarizing plate. This linearly polarized light generally gives an elliptically polarized light by the retardation plate, and especially the retardation plate is a quarter wavelength plate, and moreover when the angle between the two polarization directions of the polarizing plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarizing plate, it cannot be transmitted through the polarizing plate. As the result, mirror surface of the metal electrode may be completely covered.

### EXAMPLES

Examples of this invention will, hereinafter, be shown, and specific descriptions will be provided. In addition, “parts” in following sections represents parts by weight.

The refractive indices nx, ny, nz of protective films were measured with an automatic birefringence measuring instrument (automatic birefringence meter KOBRA21ADH, manufactured by Ohoji Keisoku Kiki K.K.) to calculate the in-plane retardation Re and the thickness direction retardation Rth.

### Example 1

(Polarizer)

A polyvinyl alcohol aqueous solution with a solid matter content of 13 weight % in which a polyvinyl alcohol resin with a polymerization degree of 2400 and a saponification degree of 98.5%, a liquid crystalline monomer (a nematic liquid crystal temperature is in the range of from 40 to 70°) having an acryloyl group at each of both terminals of a mesogen group and glycerin were mixed together so that a ratio of polyvinyl alcohol:a liquid crystalline monomer:glycerin=100:3:15 (in weight ratio) and the mixture was heated to a temperature equal to or higher than a liquid crystal temperature range and agitated with a homomixer to thereby obtain a mixed solution. Bubbles existing in the mixed solution were defoamed by leaving the solution at room temperature (23° C.) as it was, thereafter, the solution is coated by means of a casting method, subsequently thereto, and the wet coat was dried and to thereafter obtains a whitened mixed film with a thickness of 70 μm. The mixed film was heat-treated at 130° C. for 10 min.

The mixed film was immersed in a water bath at 30° C. and swollen, thereafter, the swollen film was stretched about three times while being immersed in an aqueous solution of iodine and potassium iodide in a ratio of 1 to 7 in weight (a dyeing bath, with a concentration of 0.32 weight %) at 30° C., thereafter the stretched film was further stretched to a total stretch magnification of being about six times while being immersed in a 3 weight % boric acid aqueous solution (crosslinking bath) at 50° C., followed by immersing further the stretched film in 4 weight % boric acid aqueous solution (crosslinking bath) at 60° C. Then, hue adjustment was conducted by immersing the film in 5 weight % potassium iodide aqueous solution bath at 30° C. Subsequent thereto, the film was dried at 50° C. for 4 minutes to obtain a polarizer of the present invention.

(Confirmation of Generation of Anisotropic Scattering and Measurement of Refractive Index)

The obtained polarizer was observed under a polarization microscope and it was able to be confirmed that numberless dispersed micro regions of a liquid crystalline monomer were formed in a polyvinyl alcohol matrix. The liquid crystalline monomer is oriented in a stretching direction and an average size of micro regions in the stretching direction (Δn² direction) was in the range of from 5 to 10 μm.

Refractive indices of the matrix and the micro region were separately measured. Measurement was conducted at 20° C. A refractive index of a stretched film constituted only of a polyvinyl alcohol film stretched in the same conditions as the wet stretching was measured with an Abbe's refractometer (measurement light wavelength with 589 nm) to obtain a refractive index in the stretching direction (Δn¹ direction)=1.54 and a refractive index in Δn² direction=1.52. Refractive indexes (nₑ: an extraordinary light refractive index and no: an ordinary light refractive index) of a liquid crystalline monomer were measured. An ordinary light refractive index no was measured of the liquid crystalline monomer orientation-coated on a high refractive index glass which is vertical alignment-treated with an Abbe's refractometer (measurement light with 589 nm). On the other hand, the liquid crystalline monomer is injected into a liquid crystal cell which is homogenous alignment-treated and a retardation (Δn×d) was measured with an automatic birefringence measurement instrument (automatic birefringence meter KOBRA21ADH) manufactured by Ohoji Keisokuki K.K.) and a cell gap (d) was measured separately with an optical interference method to calculate An from retardation/cell gap and to obtain the sum of Δn and nₒ as nₑ. An extraordinary light refractive index nₑ (corresponding to a refractive index in the Δn¹ direction)=1.66 and n₀ (corresponding to a refractive index of Δn² direction)=1.53. Therefore, calculation was resulted in Δn¹=1.66−1.54=0.12 and Δn²=1.52−1.52=0.00. It was confirmed from the measurement described above that a desired anisotropic scattering was able to occur.

(Protective Film)

In order to obtain a solution with a solid matter concentration of 15 weight %, 75 parts by weight of an alternating copolymer constituted of isobutene and N-methyl maleimide (a content of N-methyl maleimide is 50 mol %) and 25 parts by weight of an acrylonitrile-styrene copolymer with a content of acrylonitrile of 28 weight % were dissolved into methylene chloride. The solution caused to flow down on a polyethylene terephthalate laid down on a glass plate, the wet coat was left at room temperature for 60 minutes as it is and thereafter, the coat was peeled off from the film. The peeled coat was dried at 100° C. for 10 minutes, dried at 140° C. for 10 minutes and dried at 160° C. for 10 minutes to thereby obtain a protective film with a thickness of 100 μm. An in-plane retardation Re of the protective film was 4 nm and a thickness direction retardation Rth was 4 nm.

(Polarizing Plate)

A polarizing plate was fabricated by laminating protective films described above on both sides the polarizer using a polyurethane-based adhesive.

### Example 2

A polarizing plate was obtained in a similar way to that in Example 1 with the exception that in Example 1, a norbornene-based film with the thickness of 80 μm (manufactured by JSR Co., Ltd. with a trade name of Arton and with the in-plane retardation Re of 4 nm and the thickness direction retardation Rth of 20 nm).

### Example 3

A polarizing plate was obtained in a similar way to that in Example 1 with the exception that in Example 1, a norbornene-based film with the thickness of 40 μm (manufactured by Nippon Zeon Co., Ltd. with a trade name of ZONOA and with the in-plane retardation Re of 0.3 nm and the thickness direction retardation Rth of 7.8 nm).

### Example 4

(Protective Film)

After 100 parts by weight of a cycloolefin-based resin (manufactured by Ticona Co. with a trade name of TOPAS6013) and 5 parts by weight of a ultraviolent absorbent (manufactured by ASAHI DENKA KOGYO K.K. with a trade name of LA31) are mixed together, the mixture was dried for 5 hours, thereafter the dried mixture was supplied to an extrusion machine set at 270° C. and extruded through a T die after being melt-kneaded to take up on a cooling roll and to thereby obtain a protective film with a thickness of 40 μm. A corona treatment was applied on the obtained protective film. A solution obtained by agitating and mixing 67 parts by weight of isopropyl alcohol into 100 parts by weight of silanol (manufactured by Nippon Uniker Co. with a trade name of APZ6601) was coated on the corona-treated surface and thereafter, the wet coat was dried at 120° C. for 2 minutes to thereby form a resin layer. A thickness of the resin layer was 30 nm.

A polarizing plate was obtained in a similar way to that in Example 1 with the exception that in Example 1, a protective film (with an in-plane retardation Re of 0.8 nm and a thickness direction retardation Rth of 1.3 nm) on which the resin layer was formed was used. The protective film on which the resin layer was formed was arranged so that the resin layer is on the polarizer side.

### Example 5

(Protective Film)

Using a bar coat method, 5 ml of cyclopentanone was coated on a polyethylene terephthalate film (with the thickness of 75 μm and with the size of 10 cm in length and 20 cm in width). A triacetyl cellulose film (manufactured by Fuji Photo Film Co., Ltd. with a trade name of UZ-TAC, with the thickness of 40 μm and the size of 10 cm in length and 20 cm in width) was laminated on the cyclopentanone coated surface. The laminate was dried at 100° C. for 5 minutes and thereafter, the polyethylene terephthalate film was peeled off from the laminate to obtain a protective film constituted of a cellulose-based resin film alone.

A polarizing plate was obtained in a similar way to that in Example 1 with the exception that in Example 1, the protective film (with the in-plane retardation Re of 0.5 nm and the thickness direction retardation Rth of 5.1 nm) was used.

### Comparative Example 1

A polarizing plate was obtained in a similar way to that in Example 1 with the exception that in Example 1, a triacetyl cellulose film with a thickness of 80 μm (with the in-plane retardation Re of 2 nm and the thickness direction retardation Rth of 40 nm) was used as a protective film.

### Comparative Example 2

A polarizing plate was obtained in a similar way to that in Example 1 with the exception that in Example 1, a biaxially stretched polycarbonate film with a thickness of 80 μm (with the in-plane retardation Re of 10 nm and the thickness direction retardation Rth of 120 nm) was used as a protective film.

### Comparative Example 3

A polarizer was obtained in a similar way to that in Example 1 with the exception that in Example 1, a liquid crystalline monomer was not used. Moreover, a polarizing plate was fabricated using the polarizer in a similar way to that in Comparative Example 1.

### Comparative Example 4

A polarizer was obtained in a similar way to that in Example 1 with the exception that in Example 1, a liquid crystalline monomer was not used. Moreover, a polarizing plate was fabricated using the polarizer in a similar way to that in Example 1.

(Optical Characteristics Evaluation)

Polarizers obtained in Examples and Comparative examples were measured for optical properties using a spectrophotometer with integrating sphere (manufactured by Hitachi Ltd. U-4100). Transmittance to each linearly polarized light was measured under conditions in which a completely polarized light obtained through Glan Thompson prism polarizer was set as 100%. Transmittance was calculated based on CIE 1931 standard colorimetric system, and is shown with Y value, for which relative spectral responsivity correction was carried out. Notation k₁ represents a transmittance of a linearly polarized light in a maximum transmittance direction, and k₂ represents a transmittance of a linearly polarized light perpendicular to the direction. A result is shown in Table 1.

A polarization degree P was calculated with an equation P={(k₁−k₂)/(k₁+k₂)}×100. A transmittance T of a simple substance was calculated with an equation T=(k₁+k₂)/2.

Furthermore, polarizers obtained in Example 1 and Comparative example 3 were measured for a polarized light absorption spectrum using a spectrophotometer (manufactured by Hitachi Ltd. U-4100) with Glan Thompson prism. In FIG. 2, there are shown the maximum transmittance (k₁): a parallel transmittance and a transmittance of linearly polarized light in a direction perpendicular thereto: a perpendicular transmittance (k₂).

The polarizers of Example 1 and comparative Example 3 are equal in the all visible light range in parallel transmittance (k₁), while on the other hand, the polarizer of Example 1 is greatly smaller in perpendicular transmittance (k₂) than the polarizer of Comparative Example 3 on the shorter wavelength side due to the absorption and scattering axes. This shows that, on the shorter wavelength side, a polarization performance of the polarizer of Example 1 exceeds that of the polarizer of Comparative Example 3. Since conditions for stretching and dyeing of Example 1 are all the same as those of Comparative Example 3, an orientation degree of an iodine light absorbing material is also considered to be equal. Hence, the perpendicular transmittance (k₂) of the polarizer of Example 1 shows, as described above, that increase in polarization performance is effected by an effect due to addition of an anisotropic scattering effect to absorption by iodine.

In haze values, a haze value to a linearly polarized light in a maximum transmittance direction, and a haze value to a linearly polarized light in an absorption direction (a perpendicular direction). Measurement of a haze value was performed according to JIS K7136 (how to obtain a haze of plastics-transparent material), using a haze meter (manufactured by Murakami Color Research Institute HM-150). A commercially available polarizing plate (NPF-SEG1224DU manufactured by NITTO DENKO CORP.: 43% of simple substance transmittances, 99.96% of polarization degree) was arranged on a plane of incident side of a measurement light of a sample, and stretching directions of the commercially available polarizing plate and the sample (polarizer) were made to perpendicularly intersect, and a haze value was measured. However, since quantity of light at the time of rectangular crossing is less than limitations of sensitivity of a detecting element when a light source of the commercially available haze meter is used, light by a halogen lamp which has high optical intensity provided separately was made to enter with a help of an optical fiber device, thereby quantity of light was set as inside of sensitivity of detection, and subsequently a shutter closing and opening motion was manually performed to obtain a haze value to be calculated.

In evaluation of unevenness, in a dark room, a sample (polarizer) was arranged on an upper surface of a backlight used for a liquid crystal display, furthermore, a commercially available polarizing plate (NPF-SEG1224DU by NITTO DENKO CORP.) was laminated as an analyzer so that a polarized light axis intersect perpendicularly. And a level of the unevenness was visually observed on following criterion using the arrangement.
x: a level in which unevenness may visually be recognized

O: a level in which unevenness may not visually be recognized

TABLE 1

| | Linearly polarized light | | | | | | | |
|---|---|---|---|---|---|---|---|---|
| | transmittance (%) | | | | Haze value (%) | | | |
| | Maximum | | Transmittance | | Maximum | | Polarizer | Retardation |
| | transmission | Perpendicular | of simple | Polarization | transmission | Perpendicular | stretching | interference |
| | direction (k₁) | direction (k₂) | substance (%) | degree (%) | direction | direction | unevenness | unevenness |
| Example 1 | 87.19 | 0.034 | 43.6 | 99.92 | 1.8 | 82.0 | ∘ | ∘ |
| Example 2 | 86.95 | 0.042 | 43.5 | 99.90 | 1.6 | 82.5 | ∘ | ∘ |
| Example 3 | 87.17 | 0.030 | 43.6 | 99.93 | 1.7 | 81.9 | ∘ | ∘ |
| Example 4 | 87.17 | 0.032 | 43.6 | 99.93 | 1.6 | 82.3 | ∘ | ∘ |
| Example 5 | 86.77 | 0.029 | 43.4 | 99.93 | 1.7 | 82.0 | ∘ | ∘ |
| Comparative | 87.20 | 0.039 | 43.6 | 99.91 | 1.8 | 82.2 | ∘ | x |
| Example 1 | | | | | | | | |
| Comparative | 86.80 | 0.046 | 43.4 | 99.89 | 1.7 | 82.5 | ∘ | x |
| Example 2 | | | | | | | | |
| Comparative | 87.21 | 0.042 | 43.6 | 99.90 | 0.3 | 0.2 | x | x |
| Example 3 | | | | | | | | |
| Comparative | 87.28 | 0.034 | 43.7 | 99.92 | 0.2 | 0.2 | x | ∘ |
| Example 4 | | | | | | | | |

In the polarizing plates of the examples and the comparative examples as shown in Table 1, polarization characteristics such as transmittance of simple substances and polarization degrees are almost good. It is understood, however, that in the polarizing plates of Examples 1 and 2 and Comparative examples 1 and 2 since a polarizer is used of a structure in which minute domains are dispersed in a matrix formed with a translucent water-soluble resin containing an iodine light absorbing material, a haze value of a transmittance in perpendicular state is higher than the polarizing plate of Comparative Example 3 using an ordinary polarizer and unevenness due to fluctuation in haze value is hidden by scattering so as not be recognized. In Examples 1 and 2, it is clear from comparison with Comparative Examples 3 and 4 that stretching unevenness of a conventional polarizer is not sensed due to polarization scattering. Besides, it is understood that since a protective film small in retardation is used, interference unevenness is suppressed to be smaller as compared with Comparative Examples 1 to 3.

As a polarizer having a similar structure as a structure of a polarizer of this invention, a polarizer in which a mixed phase of a liquid crystalline birefringent material and an absorption dichroism material is dispersed in a resin matrix is disclosed in Japanese Patent Laid-Open No.2002-207118, whose effect is similar as that of this invention. However, as compared with a case where an absorption dichroism material exists in dispersed phase as in Japanese Patent Laid-Open No.2002-207118, since in a case where an absorption dichroism material exists in a matrix layer as in this invention a longer optical path length may be realized by which a scattered polarized light passes absorption layer, more scattered light may be absorbed. Therefore, this invention may demonstrate much higher effect of improvement in light polarizing performance. This invention may be realized with simple manufacturing process.

Although an optical system to which a dichroic dye is added to either of continuous phase or dispersed phase is disclosed in Japanese Patent Laid-Open No.2000-506990, this invention has large special feature in a point of using not dichroic dye but iodine. The following advantages are realized when using not dichroic dye but iodine. (1) Absorption dichroism demonstrated with iodine is higher than by dichroic dye. Therefore, polarized light characteristics will also become higher if iodine is used for a polarizer obtained. (2) Iodine does not show absorption dichroism, before being added in a continuous phase (matrix phase), and after being dispersed in a matrix, an iodine based light absorbing material showing dichroism is formed by stretching. This point is different from a dichroic dye having dichroism before being added in a continuous phase. That is, iodine exists as iodine itself, when dispersed in a matrix. In this case, in general, iodine has a far effective diffusibility in a matrix compared with a dichroic dye. As a result, iodine based light absorbing material is dispersed to all corners of a film more excellently than dichroic dye. Therefore, an effect of increasing optical path length by scattering anisotropy can be utilized for maximum, which increases polarized light function.

A background of invention given in Japanese Patent Laid-Open No.2000-506990 describes that optical property of a stretched film in which liquid droplets of a liquid crystal are arranged in a polymer matrix is indicated by Aphonin et al. However, Aphonin et al. has mentioned an optical film comprising a matrix phase and a dispersed phase (liquid crystal component), without using a dichroic dye, and since a liquid crystal component is not a liquid crystal polymer or a polymerized liquid crystal monomer, a liquid crystal component in the film concerned has a sensitive birefringence typically depending on temperatures. On the other hand, this invention provides a polarizer comprising a film having a structure where minute domains are dispersed in a matrix formed of a translucent water-soluble resin including an iodine based light absorbing material, furthermore, in a liquid crystalline material of this invention, in the case of a liquid crystal polymer, after it is orientated in a liquid crystal temperature range, cooled to room temperatures and thus orientation is fixed, in the case of a liquid crystal monomer, similarly, after orientation, the orientation is fixed by ultraviolet curing etc., birefringence of minute domains formed by a liquid crystalline material does not change by the change of temperatures.

(Durability Evaluation)

The following evaluation was conducted on the polarizing plates. Results are shown in Table 2.

<Water-Vapor Permeability of Protective film>

Measurement was conducted under test conditions of 40° C./90% R.H. (R. H. is a relative humidity) according to a method in conformity with JIS Z 0208.

<Moisture Resistance Test >

A polarizing plate cut into a test piece with the size of 25 mm×50 mm was adhered on a slide glass with an acrylic-based adhesive and optical characteristics (Initial optical characteristics) were measured, thereafter the test piece was put into a dryer in conditions of 60° C./95% R.H for 1000 hours, thereafter measurement was conducted on the following optical characteristics (optical characteristics after test) to obtain the following change quantities. Results are shown in Table 2.

Transmittance Change Quantity: A visibility factor correction was conducted to obtain a light transmittance (hereinafter referred to as simply transmittance for short) in conformity with JIS Z 8701: Transmittance change quantity=Transmittance after test−Initial transmittance

Polarization Degree Change Quantity: A polarization degree was obtained by the following equation. Herein, HO is a parallel transmittance and H90 is a perpendicular transmittance.
Polarization degree=√((H₀−H₉₀)/(H₀+H₉₀))×100 (%).
Polarization degree change quantity=Polarization degree after test−Initial polarization degree

Hue Change Quantity: Hue (a) and Hue (b) was obtained by 25 conducting a visibility factor correction in conformity with JIS Z 8701. Hue (a) change quantity=Hue (a) after test−Iinitial Hue (a), and Hue (b) change quantity=Hue (b) after test−Initial Hue (b).

TABLE 2

| | Water-vapor | | | | |
|---|---|---|---|---|---|
| | permeability | Moisture resistance test | | | |
| | of | Trans- | | | |
| | protective | mittance | Polarization | Hue (a) | Hue (b) |
| | film | change | change | change | change |
| | (g/m² · day) | quantity | quantity | quantity | quantity |
| Example 1 | 100 | 1.8 | −0.1 | −0.2 | −0.2 |
| Example 2 | 110 | 2.1 | −0.1 | −0.3 | −0.3 |
| Example 3 | 0.5 | 0.7 | −0.1 | −0.2 | −0.2 |
| Example 4 | 5 | 0.8 | −0.1 | −0.2 | −0.3 |
| Example 5 | 363 | 2.3 | −1.2 | −0.7 | −0.8 |
| Comparative | 750 | 3.8 | −2.7 | −1.2 | −1.2 |
| Example 1 | | | | | |
| Comparative | 128 | 2.0 | −0.3 | −0.5 | −0.7 |
| Example 2 | | | | | |
| Comparative | 750 | 3.9 | −2.7 | −1.2 | −1.2 |
| Example 3 | | | | | |
| Comparative | 100 | 1.9 | −0.1 | −0.2 | −0.3 |
| Example 4 | | | | | |

As shown in Table 2, it can be observed that an optical characteristic change quantity of the examples after a moisture 5 resistance test is smaller as compared to the comparative examples, and the durability of the examples is excellent.

### INDUSTRIAL APPLICABILITY

A polarizing plate of the present invention can be preferably used, alone or as an optical film obtained by lamination, in image displays such as a liquid crystal display, an organic EL display, CRT, and PDP.

1. A polarizing plate comprising a polarizer and a protective film laminated on one side or both sides of the polarizer:
wherein the polarizer comprises a monolayer film having a structure having a minute domain dispersed in a matrix formed of a translucent water-soluble resin including an iodine light absorbing material, and;
wherein the protective film satisfies an in-plane retardation, which is expressed by Re=(nx−ny) x d, of 20 nm or less, and a thickness direction retardation, which is expressed by Rth={(nx+ny)/2−nz} x d, of30 nm or less,
where the direction along with the refractive index in the film plane is maximum is defined as the X-axis, a direction perpendicular to the X-axis as the Y-axis, the thickness direction of the film as the Z-axis, and where refractive indices in each axial direction are defined as nx, ny, and nz, respectively, and the thickness of the film as d (nm).

2. The polarizing plate according to claim 1, wherein the minute domain of the polarizer is formed of an oriented birefringent material.

3. The polarizing plate according to claim 2, wherein the birefringent material shows liquid crystalline at least in orientation processing step.

4. The polarizing plate according to claim 2, wherein the minute domain of the polarizer has 0.02 or more of birefringence.

5. The polarizing plate according to claim 2, wherein in a refractive index difference between the birefringent material forming the minute domain of the polarizer and the translucent water-soluble resin in each optical axis direction,
a refractive index difference (Δn¹) in direction of axis showing a maximum is 0.03 or more, and
a refractive index difference (Δn²) between the Δn¹ direction and a direction of axes of two directions perpendicular to the Δn¹ direction is 50% or less of the Δn¹.

6. The polarizing plate according to claim 1, wherein an absorption axis of the iodine light absorbing material of the polarizer is oriented in the Δn¹ direction.

7. The polarizing plate according to claim 1, wherein the film used as the polarizer is manufactured by stretching.

8. The polarizing plate according to claim 1, wherein the minute domain has a length of 0.05 to 500 μm in a direction perpendicular to the direction of an axis showing a maximum refractive index difference between the birefringent material forming the minute domain and the translucent water-soluble resin.

9. The polarizing plate according to claim 1, wherein an iodine light absorbing material of the polarizer has an absorbing band at least in a band of 400 to 700 nm wavelength range.

10. The polarizing plate according to claim 1,
the protective film comprise at least one selected from the group of a resin compound that contains a thermoplastic resin (A) having substituted and/or non-substituted imide group in a side chain and a thermoplastic resin (B) having substituted and/or non-substituted phenyl group and nitrile group in a side chain, and a norbornene-based resin.

11. The polarizing plate according to claim 1, wherein a transmittance to a linearly polarized light in a transmission direction is 80% or more,
a haze value is 5% or less , and
a haze value to a linearly polarized light in an absorption direction is 30% or more.

12. An optical film comprising at least one of the polarizing plate according to claim 1.

13. An image display comprising the polarizing plate according to claim 1.

14. An image display comprising the optical film according to claim 12.
